(19) United States
(12) Patent Application Publication
(10) Pub. No.: US 2026/0202268 A1
(43) Pub. Date: Jul. 16, 2026

(54) TACTILE SENSOR, TACTILE SENSING METHOD, AND GRIPPER

(71) Applicants: AIDIN ROBOTICS INC., Anyang-si (KR); AJOU UNIVERSITY INDUSTRY-ACADEMIC COOPERATION FOUNDATION, Suwon-si (KR)

(72) Inventors: Uikyum KIM, Suwon-si (KR); Jeonghwa PARK, Suwon-si (KR); Sujin PARK, Suwon-si (KR); Yoon Haeng LEE, Suwon-si (KR); Yong Bum KIM, Anyang-si (KR); Ho Sang JUNG, Dongdaemun-gu (KR); Kihyeon KIM, Suwon-si (KR)

(21) Appl. No.: 19/449,081

(22) Filed: Jan. 14, 2026

(30) Foreign Application Priority Data
Jan. 14, 2025 (KR) 10-2025-0005596

(51) Int. Cl. G01L 1/14; G01L 5/22

(52) U.S. Cl. CPC G01L 1/146; G01L 5/228

(57) ABSTRACT

A tactile sensor includes a base, a substrate accommodated in the base and including a plurality of sensing elements, a cover arranged to cover the substrate and including a conductive material, the cover including a plurality of protrusions forming capacitance with the plurality of sensing elements, and an intermediate member provided between the substrate and the cover, electrically insulating the substrate from the cover, and including a plurality of receiving grooves for receiving the plurality of protrusions, respectively, wherein, when a force is applied to the cover, the plurality of protrusion move so that the capacitance between the plurality of sensing elements and the plurality of protrusions changes. Therefore, regardless of a position on the cover where the force is applied, the plurality of protrusions move in response to deformation of the intermediate member so that the force applied to the cover is estimated without a dead zone.

### CROSS-REFERENCE TO RELATED APPLICATION

This application is based on and claims priority under 35 U.S.C. § 119 to Korean Patent Application No. 10-2025-0005596, filed on Jan. 14, 2025, in the Korean Intellectual Property Office, the disclosure of which is incorporated by reference herein in its entirety.

### BACKGROUND

### 1. Field

The disclosure relates to a tactile sensor, a tactile sensing method, and a gripper.

### 2. Description of the Related Art

Research on tactile sensors, which began in the 1970s to mimic the biological tactile abilities of human skin, is being applied in various fields such as industrial robots, medicine, and agriculture. With the great developments in tactile sensor technologies since the 1980s, various types of tactile sensors including, for example, capacitive, piezoresistive, piezoelectric, and magnetic sensors have emerged. However, these technologies of the related art have drawbacks such as lack of durability or flexibility, complex systems requiring individual measuring equipment for each sensor, or difficulty in achieving both sensitivity and stability.

Techniques that use dozens of sensing elements to provide tactile sensing capabilities to the entire robot hand have been proposed, but dead zones where data acquisition is impossible may inevitably occur between the plurality of sensing elements. Thus, there is a limit in an operation of handling fine objects by grippers.

In addition, there are sensors that are configured to have flexibility similar to that of the human fingertips, but in order to secure sensitivity while maintaining this flexibility, multiple modules such as impedance sensors, underwater acoustic sensors, and temperature sensors are used to make these sensors. This results in very complex configurations and significantly expensive costs, and thus, it is difficult to widely use such sensors in robotics fields. Likewise, sensors that capture high-resolution three-dimensional (3D) surface images of objects using optical methods are expensive, are sensitive to environmental conditions, and require complex data processing, making them difficult to use as robotic sensors.

As described above, although there are many examples of achieving high performance by utilizing various sensing mechanisms or optimal designs to implement tactile sensations, it is difficult to universally apply them to robotics fields that require them.

The above-described information disclosed in the background technology of the disclosure is only intended to improve understanding of the background of the disclosure, and thus may include information that is not included in the related art.

### DOCUMENT OF PRIOR ART

### Patent Document

(PATENT DOCUMENT 1) U.S. Pat. No. 4,555,953

### SUMMARY

Provided are a tactile sensor capable of continuously measuring force without dead zones over the entire surface of a sensor even with a simple configuration and easily applicable to a gripper and a gripper including the tactile sensor.

However, the technical problems to be solved by embodiments are not limited to the problems described above, and other problems not mentioned may be clearly understood by one of ordinary skill in the art from the description of the disclosure described below.

Additional aspects will be set forth in part in the description which follows and, in part, will be apparent from the description, or may be learned by practice of the presented embodiments of the disclosure.

According to an aspect of the disclosure, a tactile sensor includes a base, a substrate accommodated in the base and including a plurality of sensing elements, a cover arranged to cover the substrate and including a conductive material, the cover including a plurality of protrusions forming capacitance with the plurality of sensing elements, and an intermediate member provided between the substrate and the cover, electrically insulating the substrate from the cover, and including a plurality of receiving grooves for receiving the plurality of protrusions, respectively, wherein the cover and the intermediate member are configured such that the plurality of protrusions are displaced relative to the plurality of sensing elements so that the capacitance between the plurality of sensing elements and the plurality of protrusions changes in response to a force applied to the cover.

The plurality of protrusions may be positioned on a surface of the cover facing the substrate and configured to move or tilt in a direction perpendicular to the surface of the substrate in response to the force applied to the cover.

The plurality of protrusions may each have a tapered shape with a cross-sectional area gradually narrowing toward the substrate.

The plurality of protrusions may each have a truncated cone shape, and the plurality of receiving grooves may each have a shape corresponding to the truncated cone shape.

The plurality of sensing elements may overlap bottom surfaces of the plurality of protrusions and may be spaced apart from the plurality of protrusions in a height direction.

The plurality of protrusions may be on an inner surface of the cover, and an outer surface of the cover may have a smooth surface without an uneven portion.

The base may include an inner groove for accommodating the substrate.

The substrate may include a control module configured to estimate a displacement of the plurality of protrusions based on a change in capacitance detected by the plurality of sensing elements and to estimate a magnitude and a position of the force applied to the cover.

The control module may be configured to estimate the magnitude and the position of the force based on capacitance data detected by the plurality of sensing elements and weight data, wherein the weight data may indicate a probability in which, when a force is applied to a protrusion corresponding to any one sensing element, a position where the force is applied corresponds to a specific sensing element.

The control module may further be configured to calculate a weight coefficient matrix based on a weight matrix representing the weight data and a transpose matrix of the capacitance data, calculate position coordinates of a contact force based on origin positions of the plurality of sensing elements and the weight coefficient matrix, and calculate a magnitude of the contact force based on the weight coefficient matrix and the capacitance data detected by each of the plurality of sensing elements.

The tactile sensor may further include a connector fastened through the base and the cover, wherein the cover may be configured to be grounded through the connector.

The cover may include a polydimethylsiloxane (PDMS) material containing conductive carbon black.

The plurality of sensing elements may be arranged to form a plurality of rows in a longitudinal direction of the substrate, and the plurality of protrusions may be arranged to correspond to the plurality of sensing elements, respectively.

The intermediate member may include an elastic material and is configured such that the plurality of receiving grooves for receiving the protrusions may be restored when the force applied to the cover is removed.

According to another aspect of the disclosure, a method of detecting a force by using a tactile sensor including a substrate including a plurality of sensing elements, a conductive cover covering the substrate and including a plurality of protrusions, and an intermediate member having an insulating property and arranged between the substrate and the cover, includes an operation in which, as a force is applied to a point of the cover, the intermediate member is deformed so that at least one protrusion adjacent to the point where the force is applied is displaced to be vertically compressed or to tilt toward the point where the force is applied, an operation in which the plurality of sensing elements of the substrate detect changes in capacitance corresponding to changes in distance between the plurality of sensing elements and the plurality of protrusions due to the displacement, and an operation in which a control module of the substrate estimates a magnitude and a position of the force applied to the cover based on the changes in capacitance.

The operation of estimating the magnitude and the position of the force may be performed by using capacitance data detected by the plurality of sensing elements and a weight matrix, wherein the weight matrix may be derived based on a correlation of a displacement measured by each of all of the sensing elements when the force is applied to the protrusion corresponding to a specific sensing element and may indicate a probability of correspondence between the position where the force is applied and the specific sensing element.

The operation of estimating the magnitude and the position of the force may include calculating a weight coefficient matrix by multiplying an inverse matrix of the weight matrix by a transpose matrix of the capacitance data, and calculating position coordinates of a contact force by calculating the weight coefficient matrix and vectors representing origin positions of the plurality of sensing elements.

According to another aspect of the disclosure, a gripper includes one or more fingers and a tactile sensor mounted on the one or more fingers, wherein the tactile sensor includes a base, a substrate accommodated in the base and including a plurality of sensing elements, a cover arranged to cover the substrate and including a conductive material, the cover including a plurality of protrusions forming capacitance with the plurality of sensing elements, and an intermediate member provided between the substrate and the cover, electrically insulating the substrate from the cover, and including a plurality of receiving grooves for receiving the plurality of protrusions, respectively, wherein the cover and the intermediate member are configured such that the plurality of protrusions are displaced relative to the plurality of sensing elements so that the capacitance between the plurality of sensing elements and the plurality of protrusions changes in response to a force applied to the cover.

The tactile sensor may be arranged on an object contact surface of the one or more fingers, and the cover may be mounted to face an outer side of the one or more fingers. Also, the one or more fingers may include a pair of fingers arranged to face each other, and the tactile sensor may be mounted on each of the pair of fingers.

The gripper may further include a driver configured to drive the one or more fingers to move with respect to each other, and a gripper controller configured to control the driver based on capacitance data output from the tactile sensor.

However, the effects which may be obtained through the disclosure are not limited to the effects described above, and other technical effects that are not mentioned may be clearly understood by one of ordinary skill in the art from the description of the disclosure described below.

### BRIEF DESCRIPTION OF THE DRAWINGS

The following drawings attached in this specification illustrate embodiments and serve to facilitate understanding of the technical concept of the disclosure, together with the description of the disclosure described below. The disclosure shall not be interpreted as being limited to the aspects shown in the drawings.

The above and other aspects, features, and advantages of certain embodiments of the disclosure will be more apparent from the following description taken in conjunction with the accompanying drawings, in which:

FIG. 1 illustrates a robot including a gripper including a tactile sensor according to embodiments;

FIG. 2 is a perspective view of a tactile sensor according to embodiments;

FIG. 3 is an exploded perspective view of the tactile sensor of FIG. 2;

(a) to (f) of FIG. 4 illustrate an arrangement of sensing elements of a tactile sensor according to embodiments;

FIG. 5 illustrates a cover according to embodiments;

(a) to (c) of FIG. 6 illustrate a protrusion according to embodiments;

FIGS. 7 to 9 three-dimensionally illustrate movement of a protrusion when a force is applied to a cover, according to embodiments; and

FIG. 10 and (a) and (b) of FIG. 11 two-dimensionally illustrate movement of a protrusion when a force is applied to a cover, according to embodiments.

FIG. 12 illustrates a gripper including a tactile sensor according to embodiments.

FIG. 13 illustrates a robot performing a cable manipulation operation according to embodiments of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, preferred embodiments of the present disclosure will be described in detail with reference to the accompanying drawings. However, the present disclosure is not limited to the specific embodiments described herein, and it will be apparent to those skilled in the art that various modifications, changes, substitutions, and additions can be made without departing from the technical spirit and scope of the present disclosure. Such modified or changed embodiments are intended to fall within the scope of the appended claims and their equivalents.

Throughout the specification, the same reference numerals generally refer to components that perform the same or similar functions. In the drawings, the size, length, thickness, or spacing of each component may be exaggerated or omitted for clarity of description. Therefore, the shapes or proportions illustrated in the drawings are merely exemplary and may vary due to various design modifications in actual implementation.

In addition, in describing the present disclosure, detailed descriptions of well-known technologies, configurations, and operating principles that are widely known in the relevant art or can be easily understood by those skilled in the art will be omitted or briefly mentioned to avoid unnecessarily obscuring the subject matter of the present disclosure. Such known technologies, configurations, and principles may be combined with the embodiments of the present disclosure, and those skilled in the art can easily derive various embodiments by combining them with the contents described herein.

Furthermore, unless explicitly defined otherwise, terms used herein have meanings commonly understood in technical dictionaries or the relevant art. Singular forms may include plural forms unless the context clearly indicates otherwise. Terms such as “comprises” or “may include” are intended to mean that the presence or addition of elements other than those listed is not excluded.

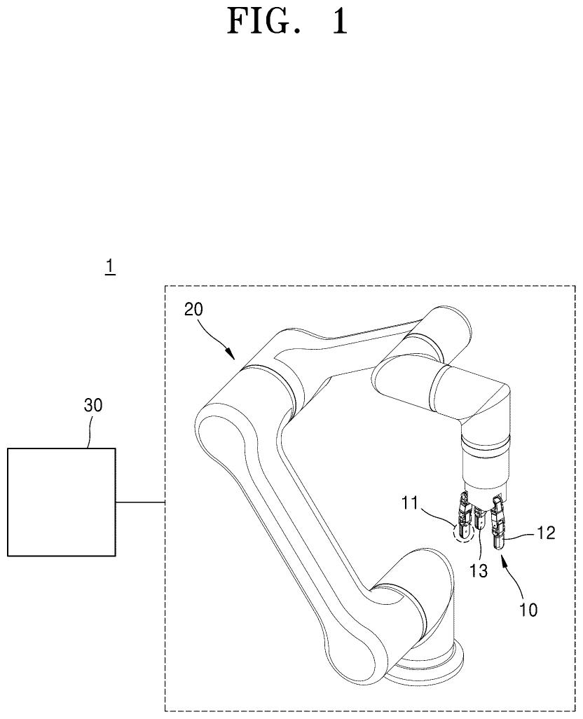

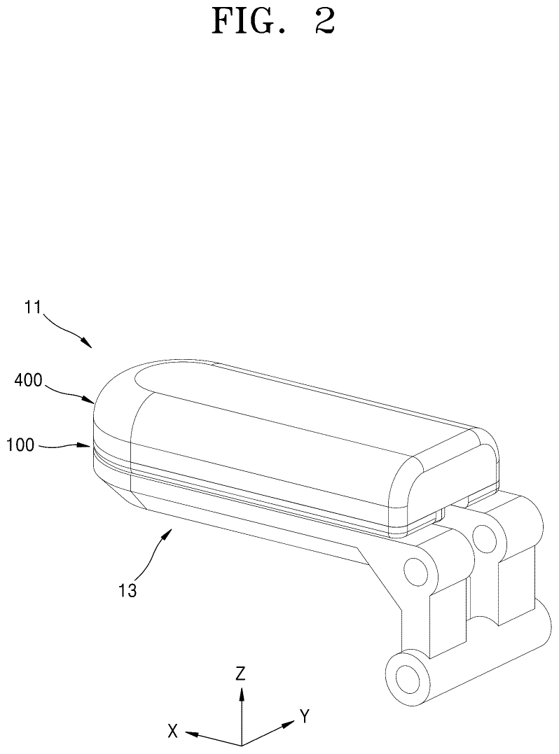

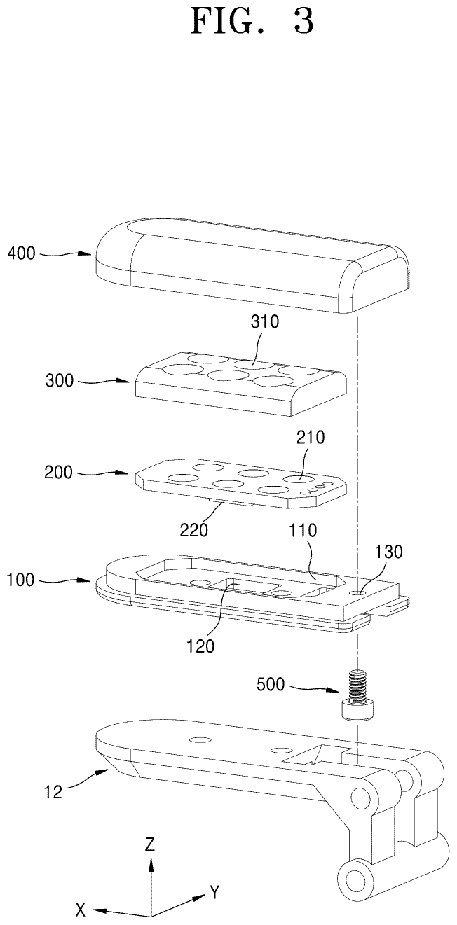

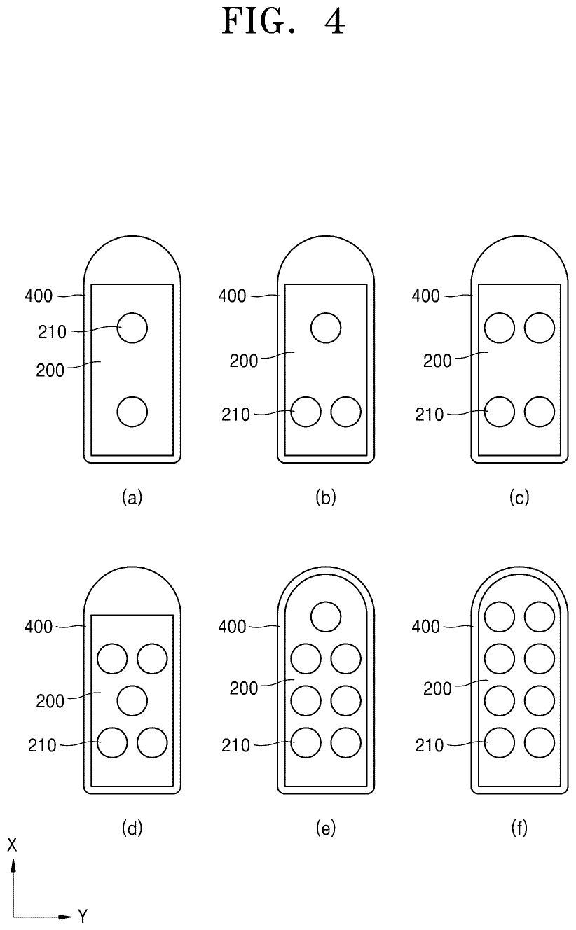

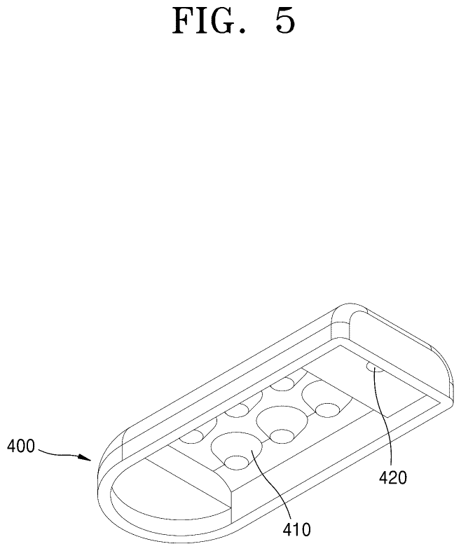

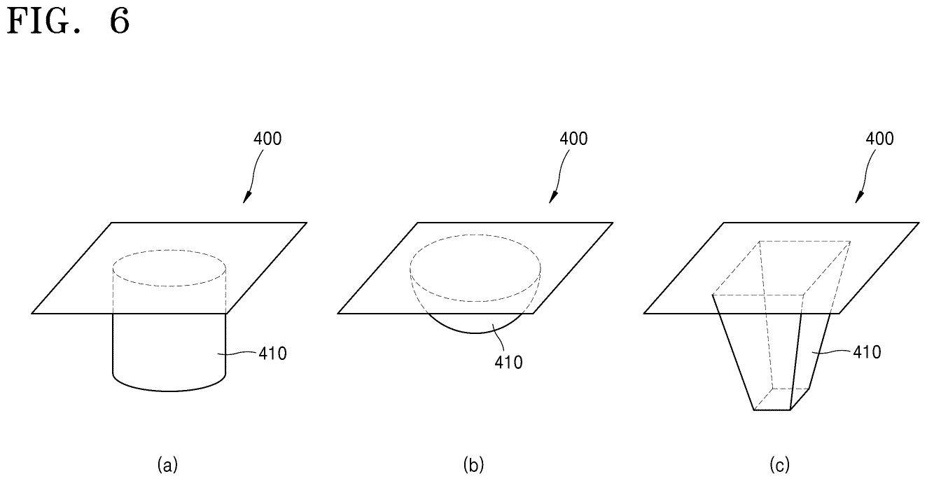

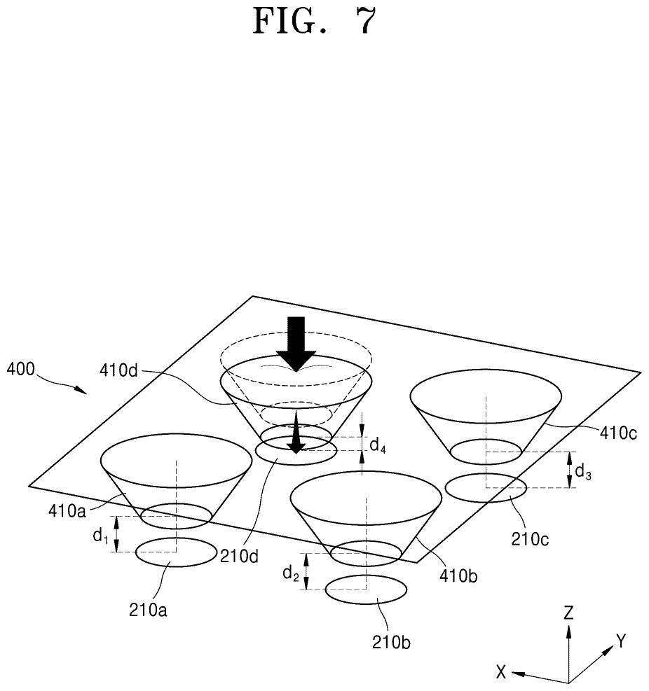

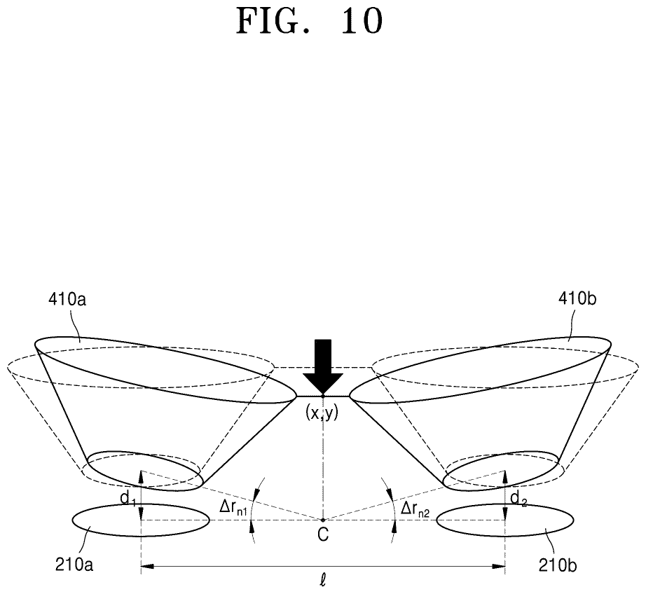

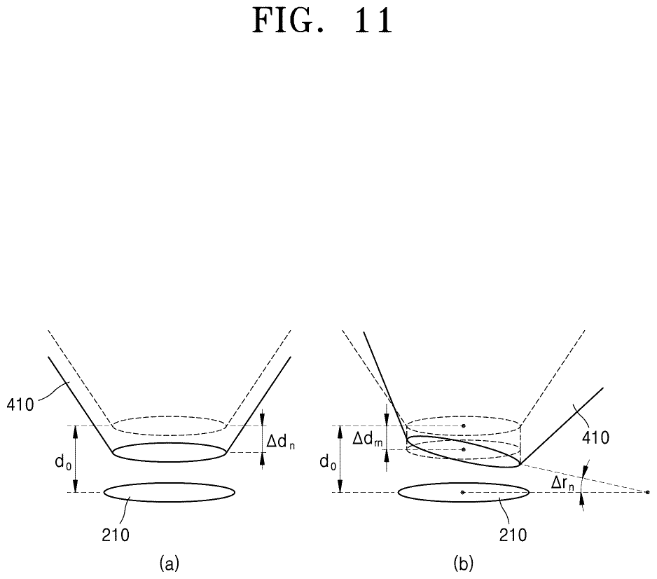

FIG. 1 illustrates a robot 1 including a gripper 10 including a tactile sensor 11 according to embodiments, FIG. 2 is a perspective view of the tactile sensor 11 according to embodiments, FIG. 3 is an exploded perspective view of the tactile sensor 11 of FIG. 2, FIGS. 4A to 4F illustrate an arrangement of sensing elements 210 of the tactile sensor 11 according to embodiments, FIG. 5 illustrates a cover 400 according to embodiments, FIG. 6 illustrates a protrusion 410 according to embodiments, FIGS. 7 to 9 three-dimensionally illustrate movement of the protrusion 410 when a force is applied to the cover 400, according to embodiments, and FIGS. 10 and 11 two-dimensionally illustrate movement of the protrusion 410 when a force is applied to the cover 400, according to embodiments.

The tactile sensor 11 according to embodiments may measure information generated from physical interaction with a surrounding environment. The tactile sensor 11 may be applied to electronic devices with touch interaction capabilities such as robots, medical devices, smartphones, or tablets, operation interfaces or driving assistance systems of automobiles, biometric recognition systems, virtual reality (VR)/augmented reality (AR) devices, etc. For example, as shown in FIG. 1, the tactile sensor 11 according to embodiments may be applied to the gripper 10 of the robot 1.

The gripper 10 may be included in the robot 1 together with a robot arm 20 and a gripper controller 30. The robot 1 may include a collaborative robot that performs logistics transport work, delicate processing work, or serving work together with workers in a logistics factory. Alternatively, the robot 1 may include a medical device or may be used as a manufacturing robot. The robot 1 may include a bipedal or quadrupedal robot, or a mobile robot including wheels or tracks. Alternatively, the robot 1 may be fixed to a work site. The gripper 10 may include a finger 12 and the tactile sensor 11 mounted on the finger 12.

The robot arm 20 may have a plurality of rotation axes as joints of the robot 1. For example, the robot arm 20 may be a 6-axis robot rotatably mounted in a work area and may have an end on which the gripper 10 may be mounted. The robot arm 20 may be connected to the gripper controller 30 by wire or wirelessly and may operate by receiving an instruction from the gripper controller 30. The gripper controller 30 may include a processor, memory, a communication device, etc. to control an operation of the robot 1. The gripper controller 30 may control rotation and positioning of the robot arm 20 and may control an operation of the gripper 10. For example, the gripper controller 30 may send a signal to the robot arm 20 to move the gripper 10 to an object or to move the gripper 10 to a loading position while the gripper 10 is holding an object. The gripper controller 30 may control the gripper 10 to grip or release an object by sending a grip or release signal to the gripper 10.

The gripper controller 30 may be connected to the gripper 10 and the robot arm 20 by wire/wirelessly, and may detect interaction between the tactile sensor 11 and an external environment based on a change in capacitance detected by the tactile sensor 11. The gripper controller 30 may control operations of the gripper 10 and the robot arm 20. Alternatively, the gripper controller 30 may be included in the gripper 10. In this case, the gripper 10 may include the tactile sensor 11, the finger 12, and the gripper controller 30.

The gripper controller 30 may utilize a direct circuit structure for executing each control function through one or more microprocessors or other control devices such as memory, a processor, a logic circuit, a look-up table, etc. The gripper controller 30 may be implemented as a module, a program, or part of a code containing one or more executable instructions for executing a specific logic function. The gripper controller 30 may include or may be implemented by a processor, such as a central processing unit (CPU) that executes each function or a microprocessor. The gripper controller 30 may include a communication device capable of transmitting and receiving data to and from an external device, etc. The communication device may include one or more combinations of a digital modem, a radio frequency (RF) modem, an antenna circuit, a WiFi chip, and associated software and/or firmware.

The gripper controller 30 may be included in a tactile sensor system, together with the gripper 10 including the tactile sensor 11. For example, the tactile sensor system may include the gripper 10 and the gripper controller 30 of the robot 1 and exclude the robot arm 20 of the robot 1. In this case, the arithmetic operation, calculation, and/or estimation of the tactile sensor 11 described below may be performed by a substrate 200, by the gripper controller 30, or separately by the substrate 200 and the gripper controller 30.

In one embodiment, the tactile sensor 11 may be arranged on an object contact surface of the finger 12, and the cover 400 of the tactile sensor 11 described below may be mounted to face the outside of the finger 12. Also, the finger 12 may include a pair of fingers 12 arranged to face each other, and the tactile sensor 11 may be mounted on each of the pair of fingers 12.

In one embodiment, the gripper 10 may include a driver configured to drive the fingers 12 to move with respect to each other and may include the gripper controller 30 configured to control the driver based on capacitance data output from the tactile sensor 11. The driver may include an actuator including a hydraulic/pneumatic cylinder, an electric motor, etc. and may include a plurality of link assemblies and/or gear assemblies operated by the actuator.

The tactile sensor 11 may measure the magnitude and position of force applied by an object. For example, the tactile sensor 11 may be provided on each of the plurality of fingers 12 included in the gripper 10. The tactile sensor 11 may measure in real time the force applied when the plurality of fingers 12 of the gripper 10 grip the object. The tactile sensor 11 may include a capacitive sensor. The tactile sensor 11 may be connected to the gripper controller 30, and the gripper controller 30 may calculate the force applied to the tactile sensor 11, based on a change in capacitance detected by the tactile sensor 11. The tactile sensor 11 may measure the force in real time across the entire contact surface area of the tactile sensor 11 without dead zones.

The tactile sensor 11 may be supported on a fingertip 13 of the finger 12. For example, as shown in FIGS. 2 and 3, the fingertip 13 may be provided at a front end of each of the plurality of fingers 12, and the tactile sensor 11 may be mounted on a surface of the fingertip 13 facing the object. Alternatively, the tactile sensor 11 may be mounted on a joint part of the finger 12 or a palm in addition to the fingertip 13.

The tactile sensor 11 according to embodiments may include: a base 100; the substrate 200 accommodated in the base 100 and including the plurality of sensing elements 210; the cover 400 which is conductive and configured to cover the substrate 200, the cover 400 including the plurality of protrusions 410 configured to form capacitance with the plurality of sensing elements 210; and an intermediate member 300 arranged between the substrate 200 and the cover 400, electrically insulating the substrate 200 from the cover 400, and including a plurality of receiving grooves 310 for accommodating the plurality of protrusions 410, wherein, when a force is applied to the cover 400, the plurality of protrusions 410 may move so that the capacitance between the plurality of sensing elements 210 and the plurality of protrusions 410 may change.

The tactile sensor 11 may include the base 100, the substrate 200, the intermediate member 300, the cover 400, and a connector 500.

The base 100 may be supported on the finger 12 of the gripper 10 and may connect the tactile sensor 11 to the gripper 10. For example, as shown in FIGS. 2 and 3, the base 100 may be supported on an upper surface of the finger 12 using screws, welding, an adhesive, or the like and may accommodate the substrate 200.

The base 100 may include a first inner groove 110, a second inner groove 120, and a first connecting hole 130.

The first inner groove 110 may be formed in an upper surface of the base 100 and may accommodate the substrate 200 on an inner side thereof. As shown in FIG. 3, the first inner groove 110 may form a step difference from the upper surface of the base 100 and may have a shape corresponding to the substrate 200. While the substrate 200 is being accommodated in the first inner groove 110, the substrate 200 may have an upper surface at the same height as or a lower height than the upper surface of the base 100. Thus, the size of the tactile sensor 11 may be reduced in a height direction (or a Z-axis direction of FIG. 3) of the tactile sensor 11, and the substrate 200 may not interfere with the intermediate member 300 and/or the cover 400 when the tactile sensor 11 is in contact with an object.

The second inner groove 120 may be formed in the upper surface of the base 100 and may accommodate a control module 220 on an inner side thereof. As shown in FIG. 3, the second inner groove 120 may form a step difference form an upper surface of the first inner groove 110 and may be formed on the inner side of the first inner groove 110. The second inner groove 120 may be recessed below the first inner groove 110 and may have a shape corresponding to the control module 220 of the substrate 200. With the control module 220 being accommodated in the second inner groove 120, the control module 220 may have an upper surface at the same height as or a lower height than the upper surface of the first inner groove 110. Thus, the size of the tactile sensor 11 may be reduced in a height direction (or a Z-axis direction of FIG. 3) of the tactile sensor 11, and the control module 220 may not interfere with the intermediate member 300 and/or the cover 400 when the tactile sensor 11 is in contact with an object.

The first connecting hole 130 may be formed in the base 100, and the connector 500 may be inserted into the first connecting hole 130. The first connecting hole 130 may be connected through a second connecting hole 420 of the cover 400, and at least a portion of the connector 500 inserted into the first connecting hole 130 may be inserted into the second connecting hole 420. Thus, the cover 400 electrically connected through the connector 500 may be grounded. For example, as shown in FIG. 3, the first connecting hole 130 may be formed at a rear end of the base 100 and may be coaxial with the second connecting hole 420 of the cover 400.

The substrate 200 may detect a force applied from the outside. The substrate 200 may detect a change in capacitance formed between the cover 400 and the substrate 200, when the cover 400 moves by being in contact with an object. The substrate 200 may convert the change in capacitance into a digital signal and transmit the digital signal to the gripper controller 30, and the gripper controller 30 may calculate the force based on the change in capacitance. Alternatively, the substrate 200 may directly calculate the force based on the change in capacitance. The arithmetic operation, calculation, and/or estimation of the tactile sensor 11 described below may be performed by the substrate 200, by the gripper controller 30, or separately by the substrate 200 and the gripper controller 30. For example, the substrate 200 may perform an operation of estimating the position and magnitude of the force through the control module 220, or the substrate 200 may transmit, to the gripper controller 30, through a communication module, a change in capacitance detected by the plurality of sensing elements 210, and the gripper controller 30 may estimate, based on the transmitted change in capacitance, the position and magnitude of the force. The substrate 200 may be connected to the gripper controller 30 or other external devices by wire or wirelessly. The substrate 200 may include a printed circuit board (PCB) and may be accommodated in the first inner groove 110 of the base 100.

The substrate 200 may apply a predetermined voltage to the sensing elements 210 and/or the cover 400. For example, the substrate 200 may apply the voltage to the sensing elements 210 to radiate an electric field signal and may connect the cover 400 to the ground. For example, the substrate 200 may detect a change in capacitance and estimate the magnitude of force. The change in capacitance may be the difference between an initial capacitance between the cover 400 and the substrate 200 (or between the protrusions 410 and the sensing elements 210) and a capacitance after the force is applied. For a method of detecting the change in capacitance and of estimating the magnitude of force based on the detected change in capacitance, well known techniques, such as capacitance calculation formulas and the Hooke's law, may be referred to, and their detailed descriptions are omitted. For example, the change in capacitance and the magnitude of force may be calculated by using the equations below.

$$Δ C = C - {C}_{0} = {ε}_{0} {ε}_{r} ( \frac{A}{d} - \frac{A}{{d}_{0}} )$$

$$F = - \frac{{ε}_{0} {ε}_{r} {EA}^{2}}{{d}_{0} ( {C}_{0} + Δ C )} + EA = f ( Δ C )$$

Here, ΔC represents a change in capacitance, C represents a capacitance after force is applied, C₀ represents an initial capacitance, ε₀ represents a dielectric constant, εᵣ represents a permittivity, A represents an overlapping area of the sensing element 210 and the protrusion 410, d represents a distance between the sensing element 210 and the protrusion 410 after the force is applied, d₀ represents an initial distance between the sensing element 210 and the protrusion 410, and E represents the Young's modulus of the intermediate member 300.

The substrate 200 may include the sensing element 210 and the control module 220.

The sensing element 210 may include a conductive (e.g., metal) electrode for forming capacitance with the cover 400. For example, as shown in FIG. 3, the sensing element 210 may be positioned on an upper surface of the substrate 200 and may face the cover 400. The sensing element 210 may be spaced apart from the cover 400 (the protrusion 410 of the cover 400) without being in contact with the cover 400 (the protrusion 410 of the cover 400). For example, the sensing element 210 may be positioned below the protrusion 410 to correspond to a bottom surface of the protrusion 410 (a side surface of the substrate 200). The sensing element 210 may have various shapes, for example, a circular shape, an oval shape, or a polygonal shape such as a triangular shape or a square shape. The area of the sensing element 210 may be greater than the area of the bottom surface of the protrusion 410. For example, even when the cover 400 is pressed so that the protrusion 410 moves, the bottom surface of the deformed protrusion 410 may not deviate from the sensing element 210. Thus, the sensing element 210 may further accurately detect a change in capacitance according to the deformation of the protrusion 410.

The sensing element 210 may include the plurality of sensing elements 210. The plurality of sensing elements 210 may be spaced apart from each other and may correspond to the plurality of protrusions 410, respectively. For example, as shown in FIG. 3, the sensing element 210 may include six sensing elements 210. The six sensing elements 210 may be arranged in two rows in a longitudinal direction (e.g., an X-axis direction of FIG. 3) of the tactile sensor 11, and each row may include three tactile sensors 11. The plurality of sensing elements 210 may respectively overlap the bottom surfaces of the plurality of protrusions 410 and be respectively spaced apart from the plurality of protrusions 410 in the height direction.

Alternatively, the number of sensing elements 210 may be 2, 3, 4, 5, 7, or 8 or more. For example, as shown in (a) of FIG. 4, the sensing element 210 may include two sensing elements 210. The two sensing elements 210 may be positioned on a front side and a rear side of the substrate 200, respectively. The two sensing elements 210 may be the minimum number for estimating a position of the cover 400 where a force is applied on a plane (e.g., an XY plane of FIG. 4). The tactile sensor 11 according to the embodiments may estimate the position of the force applied to the cover 400 while simplifying a structure of the substrate 200 by including two sensing elements 210.

Alternatively, as shown in (b) of FIG. 4, the sensing element 210 may include three sensing elements 210. One sensing element 210 may be positioned on a front side or a rear side of the substrate 200, and two sensing elements 210 may be positioned on the rear side or the front side of the substrate 200. The three sensing elements 210 may be the minimum number for estimating the position and magnitude of the force applied to the cover 400 on a plane. The tactile sensor 11 according to embodiments may estimate the position and magnitude of the force applied to the cover 400 while simplifying the structure of the substrate 200 by including only three sensing elements 210.

Alternatively, as shown in (c) of FIG. 4, the sensing element 210 may include four sensing elements 210. The four sensing elements 210 may have a 2*2 arrangement. Two sensing elements 210 may be positioned on a front side of the substrate 200 and the remaining two sensing elements 210 may be positioned on a rear side of the substrate 200. The tactile sensor 11 according to embodiments may include the four sensing elements 210, and thus may further accurately estimate the position and magnitude of the force applied to the cover 400.

Alternatively, as shown in (d) of FIG. 4, the sensing element 210 may include five sensing elements 210. The five sensing elements 210 may have an arrangement of 2, 1, 2, an arrangement of 1, 2, 2, or an arrangement of 2, 2, 1. The tactile sensor 11 according to embodiments may obtain a wider detection area in a longitudinal direction of the substrate 200 by including the five sensing elements 210 and may further accurately estimate the position and magnitude of the force applied to the cover 400.

Alternatively, as shown in (e) of FIG. 4, the sensing element 210 may include seven sensing elements 210. The seven sensing elements 210 may have a 1*2*2*2 arrangement. One sensing element 210 may be positioned at a front-most side of the substrate 200, other two sensing elements 210 may be positioned at a rear side of the substrate 200, and the other 2*2 sensing elements 210 may be in between. Here, the substrate 200 may have a shape corresponding to a shape of the cover 400 having a streamlined or rounded front, and one sensing element 210 arranged at the front side may be positioned at a front curved portion of the substrate 200. The tactile sensor 11 according to embodiments may include the seven sensing elements 210, and thus may further accurately estimate the position and magnitude of the force applied to the cover 400. Additionally, the tactile sensor 11 may accurately estimate the force applied to a front portion of the cover 400.

Alternatively, as shown in (f) of FIG. 4, the sensing element 210 may include eight sensing elements 210. The eight sensing elements 210 may have a 2*2*2*2 arrangement. Two sensing elements 210 may be positioned at a front-most side of the substrate 200, other two sensing elements 210 may be positioned at a rear side of the substrate 200, and the other 2*2 sensing elements 210 may be positioned in between. Here, the substrate 200 may have a shape corresponding to a shape of the cover 400 having a streamlined or rounded front, and the two sensing elements 210 arranged at the front side may be positioned at a front curved portion of the substrate 200. The tactile sensor 11 according to embodiments may include the eight sensing elements 210, and thus may further accurately estimate the position and magnitude of the force applied to the cover 400. Also, the tactile sensor 11 may further accurately estimate the force applied to a front portion of the cover 400.

The control module 220 may be connected to the substrate 200, and the control module 220 may directly calculate the magnitude and/or the position of the force applied to the cover 400, based on a change in capacitance formed between the sensing element 210 and the cover 400, or may transmit the change in capacitance to an external device, such as the gripper controller 30, using a communication module equipped in the control module 220. In one embodiment, the control module 220 may be configured to estimate displacements of the plurality of protrusions 410, based on changes in capacitance detected by the plurality of sensing elements 210, and estimate the magnitude and position of the force applied to the cover 400.

For example, as shown in FIG. 3, the control module 220 may be mounted on a bottom surface (e.g., the opposite surface to a surface on which the sensing elements 210 are mounted) of the substrate 200. For example, the control module 220 may include clock domain crossing (CDC) configured to convert, into a digital signal, a change in capacitance, which is an analog signal detected by a sensing electrode 22, a detection circuit configured to detect the force/torque, and a communication module configured to communicate with a microcontroller unit (MCU), an external controller, or a user terminal.

In one embodiment, the control module 220 may be configured to estimate the magnitude and position of force, based on capacitance data detected by the plurality of sensing elements 210 and weight data. Here, the weight data refers to data related to a probability in which a position where a force is applied may correspond to a specific sensing element 210 when the force is applied to a protrusion corresponding to any one sensing element 210.

In one embodiment, the control module 220 may be configured to calculate a weight coefficient matrix, based on a weight matrix representing the weight data and a transpose matrix of the capacitance data, and calculate position coordinates of a contact force, based on origin positions of the plurality of sensing elements 210 and the weight coefficient matrix.

In one embodiment, the control module 220 may be configured to calculate the magnitude of the contact force, based on the weight coefficient matrix and contact force data detected by each of the plurality of sensing elements 210.

The control module 220 may utilize a direct circuit structure for executing each control function through one or more microprocessors or other control devices such as memory, a processor, a logic circuit, a look-up table, etc. The control module 220 may be implemented as a module, a program, or part of a code containing one or more executable instructions for executing a specific logic function. The control module 220 may include or may be implemented by a processor, such as a CPU that executes each function or a microprocessor. The control module 220 may include a communication device capable of transmitting and receiving data to and from an external device, etc. The communication device may include one or more combinations of a digital modem, an RF modem, an antenna circuit, a WiFi chip, and associated software and/or firmware.

The intermediate member 300 may be positioned between the substrate 200 and the cover 400, may electrically insulate the substrate 200 from the cover 400, and may prevent the cover 400 from being in contact with the substrate 200. The intermediate member 300 may accommodate the protrusions 410 of the cover 400 and may include an elastic material that is changeable by an external force. For example, the intermediate member 300 may include an elastomer serving as a dielectric. The intermediate member 300 may connect (e.g., attach) the substrate 200 to the cover 400 and may prevent the substrate 200 and the cover 400 from being separated from each other.

The intermediate member 300 may transmit the force applied by an object to the tactile sensor 11 to the protrusions 410, thereby causing movement or deformation of the protrusions 410. For example, when a downward force is applied to the protrusion 410 positioned directly above the sensing element 210, the protrusion 410 may move downwards and may be compressed while being accommodated in the intermediate member 300 and a gap between the sensing element 210 and the protrusion 410 may be reduced to cause a change in capacitance. Alternatively, when a force is applied between the neighboring sensing elements 210, the protrusions 410 may rotate or tilt while being accommodated in the intermediate member 300, and the gaps between the sensing elements 210 and the protrusions 410 may change or the areas of regions of the protrusions 410 facing the sensing elements 210 may change to cause a change in capacitance.

The intermediate member 300 may include the receiving groove 310. As shown in FIG. 3, the receiving groove 310 may be positioned in a surface of the intermediate member facing the cover (e.g., an upper surface of the intermediate member 300). The receiving groove 310 may surround the protrusions 410. The receiving groove 310 may include the plurality of receiving grooves 310 (e.g., six) equal in number to the plurality of protrusions 410. The sizes and/or shapes of the receiving groove 310 may correspond to the sizes and/or shapes of the protrusions 410.

The cover 400 may wrap the tactile sensor 11 and provide a contact area for gripping the object. The cover 400 may be mounted on the base 100 and may include an inner space to accommodate the substrate 200 and the intermediate member 300 between the cover 400 and the base 100. As shown in FIG. 3, the cover 400 may have a shape similar to a finger, may have a front side that is curved in a rounded manner, and may include an upper flat surface so as to be in contact with the object. The cover 400 may include a hard material (e.g., metal or conductive polymers). For example, the cover 400 may include a conductive carbon black polydimethylsiloxane (PDMS) material. The cover 400 may include a PDMS matrix in which carbon black is included as a conductive filler to form a network between particles. Thus, even when an external force is applied thereto, the cover 400 may retain excellent elasticity and electrical properties. For example, the cover 400 may include PDMS containing carbon black in 10 wt % and may thus have sufficient conductivity while maintaining a smooth surface.

The cover 400 may be connected to the ground through the connector 500, and all or part of the cover 400 may be a ground electrode. When a predetermined voltage is applied to the cover 400, the cover 400 may form capacitance with the sensing element 210. For example, a voltage applied to the sensing element 210 and the voltage applied to the cover 400 may have opposite signs.

The cover 400 may include the protrusion 410 and the second connecting hole 420.

The protrusion 410 may be on a surface of the cover 400 facing the substrate 200 (e.g., an inner upper surface of the cover 400). The protrusion 410 may be located at a position corresponding to the sensing element 210. The protrusion 410 may be accommodated in the receiving groove 310. The protrusion 410 may have a height corresponding to a depth of the receiving groove 310, and an outer surface of the protrusion 410 may be supported on an inner surface of the receiving groove 310. Also, a lower surface of the protrusion 410 facing the substrate 200 may be supported on a bottom surface of the receiving groove 310. The protrusion 410 may include the plurality of protrusions 410 (e.g., six). The plurality of protrusions 410 may be formed on the surface of the cover 400 facing the substrate 200 and may be vertically displaced or tilted when a force is applied to the cover 400.

The protrusions 410 may have a three-dimensional (3D) shape. For example, as shown in FIG. 5, the protrusions 410 may have a shape of a circular truncated cone having a cross-sectional area gradually narrowing downwards. Thus, the stress applied to upper portions of the protrusions 410 adjacent to a contact area may be concentrated on lower portions of the protrusions 410, so that the magnitude and position of the force applied to the cover 400 may be further accurately estimated. For example, the protrusions 410 may have a tapered shape having a cross-sectional area gradually narrowing downwards.

Alternatively, as shown in (a) of FIG. 6, the protrusions 410 may have a cylindrical shape. Alternatively, as shown in (b) of FIG. 6, the protrusions 410 may have a hemispherical shape or a shape in which a portion of a sphere is cut off. Alternatively, as shown in (c) of FIG. 6, the protrusions 410 may have a frustum shape. In addition to this, the protrusions 410 may have a prismatic shape, a cone shape, a pyramidal shape, etc.

The second connecting hole 420 may be formed in an inner surface of the cover 400 as a hole through which the connector 500 is connected. For example, as shown in FIG. 5, the second connecting hole 420 may be formed on a rear side of the cover 400 in an inner upper surface of the cover 400. The second connecting hole 420 may include, on an inner surface thereof, a screw thread corresponding to the connector 500 so that the connector 500 may be fastened thereto. Alternatively, the connector 500 may be fastened to the second connecting hole 420 using a conductive adhesive, welding, etc. The cover 400 may be connected to the ground through the connector 500 fastened to the second connecting hole 420 so as to function as a ground electrode.

The cover 400 according to embodiments may include an uneven portion or a dome structure on an inner surface thereof to improve the detection performance, and thus, the shape of an outer surface and/or the structure which may be added to the outer surface are/is not limited.

For example, the cover 400 may have a smooth surface that is in contact with the object and may not include an uneven portion. Thus, even when the cover 400 is intactly applied to the finger 12 of the gripper 10, etc., the cover 400 may not reduce the force with which the finger 12 may grip the object. That is, the tactile sensor 11 according to embodiments may be intactly applied to the gripper 10.

Alternatively, the cover 400 may be equipped with additional sensors such as a fingerprint structure or a slip sensor, formed on the outer surface thereof to increase friction.

In one embodiment, the cover 400 and the intermediate member 300 may be configured such that the plurality of protrusions 410 may be displaced relative to the plurality of sensing elements 210 so that a capacitance between the plurality of sensing elements 210 and the plurality of protrusions 410 may change in response to a force applied to the cover 400.

The connector 500 may be inserted into the first connecting hole 130 and the second connecting hole 420 and may be electrically connected to the cover 400. The connector 500 may be connected to the ground directly or through the external gripper controller 30 or the substrate 200.

Operations of the tactile sensor 11 according to embodiments are described with reference to FIGS. 7 to 9. FIGS. 7 to 9 three-dimensionally illustrate movement of the protrusions 410 when a force is applied to the cover 400, according to embodiments. For convenience, in FIGS. 7 to 9, only a first protrusion 410a, a second protrusion 410b, a third protrusion 410c, and a fourth protrusion 410d are shown as four of the protrusions 410, and only a first sensing element 210a, a second sensing element 210b, a third sensing element 210c, and a fourth sensing element 210d are shown as four of the sensing elements 210. As shown in FIG. 7, as an external force is applied to the cover 400 (the fourth protrusion 410d corresponding to the fourth sensing element 210d), bottom surfaces of the first protrusion 410a, the second protrusion 410b, the third protrusion 410c, and the fourth protrusion 410d may be respectively spaced apart from the first sensing element 210a, the second sensing element 210b, the third sensing element 210c, and the fourth sensing element 210d by distances d1, d2, d3, and d4, respectively.

FIG. 7 shows a case where the external force is applied to a position of the cover 400 directly above any one of the plurality of protrusions 410. In this state, as shown in FIG. 7, when the force is applied to the center of the fourth protrusion 410d, the fourth protrusion 410d may move downwards and may be compressed. Here, the intermediate member 300 configured to accommodate the fourth protrusion 410d may also be deformed. And as a gap between the fourth protrusion 410d and the fourth sensing element 210d decreases, a change may occur in a capacitance formed between the fourth protrusion 410d and the fourth sensing element 210d. The substrate 200 may estimate the magnitude and position of the applied force, based on the change in capacitance.

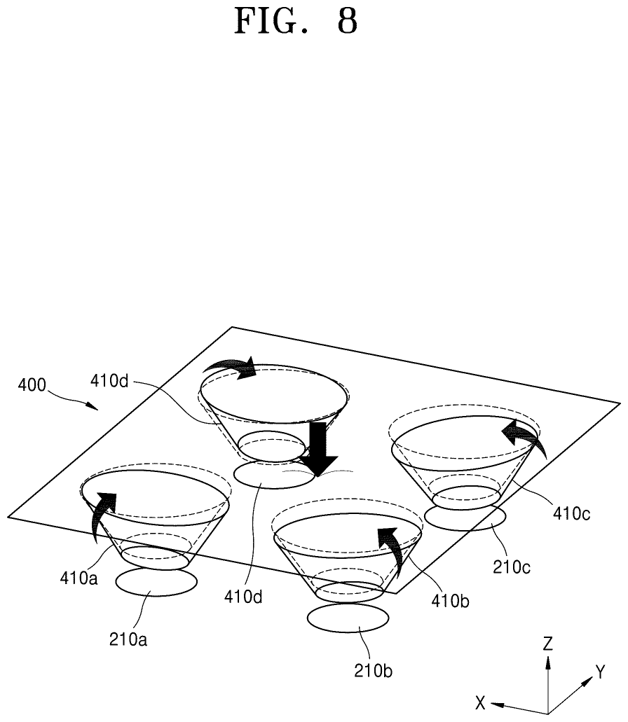

FIG. 8 shows a case where an external force is applied to a position of the cover 400 not overlapping the plurality of protrusions 410. In this state, as shown in FIG. 8, when the external force is applied to a certain point of the cover 400 not overlapping the four protrusions 410 and positioned between the four protrusions 410, the four protrusions 410 may not only move downwards but may also tilt toward the point where the external force is applied. That is, as the intermediate member 300 is deformed, the receiving grooves 310 surrounding the four protrusions 410 may be deformed, and thus, the four protrusions 410 may also move. Also, a change may also occur in a capacitance formed between each of the first protrusion 410a, the second protrusion 410b, the third protrusion 410c, and the fourth protrusion 410d, and each of the first sensing element 210a, the second sensing element 210b, the third sensing element 210c, and the fourth sensing element 210d. The substrate 200 may estimate the magnitude and position of the applied force, based on the changes in capacitance.

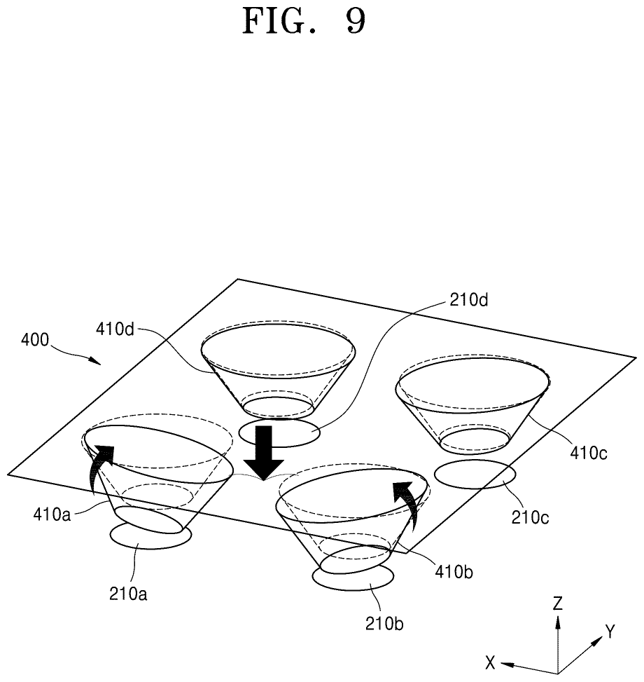

FIG. 9 shows a case where an external force is applied to a position of the cover 400 not overlapping the plurality of protrusions 410 but relatively closer to some of the protrusions 410. In this state, as shown in FIG. 9, when the external force is applied to a certain point of the cover 400 not overlapping the four protrusions 410 and positioned between the first protrusion 410a and the second protrusion 410b, the four protrusions 410 may not only move downwards but may also tilt toward the point where the external force is applied. That is, as the intermediate member 300 is deformed, the receiving grooves 310 surrounding the four protrusions 410 may be deformed, and thus, the four protrusions 410 may also move. In particular, the first protrusion 410a and the second protrusion 410b may tilt in a relatively greater degree toward the point where the force is applied. Depending on the magnitude and position of the applied force, the third protrusion 410c and the fourth protrusion 410d may also move by a smaller displacement. Thus, a change may also occur in a capacitance formed between each of the first protrusion 410a, the second protrusion 410b, the third protrusion 410c, and the fourth protrusion 410d and each of the first sensing element 210a, the second sensing element 210b, the third sensing element 210c, and the fourth sensing element 210d. The substrate 200 may estimate the magnitude and position of the applied force, based on the change in capacitance.

Operations of the tactile sensor 11 according to embodiments are described with reference to FIGS. 10 and 11. FIGS. 10 and 11 two-dimensionally illustrate movement of the protrusion 410 when a force is applied to the cover 400, according to embodiments. For convenience, in FIG. 10, only the first protrusion 410a and the second protrusion 410b are shown as two of the protrusions 410, and only the first sensing element 210a and the second sensing element 210b are shown as two of the sensing elements 210.

FIG. 10 shows a case where a force is applied to a point (x, y) between the first protrusion 410a and the second protrusion 410b. When the force is applied to the point (x, y), the first protrusion 410a and the second protrusion 410b may tilt toward the point (x, y). In this case, the first protrusion 410a and the second protrusion 410b may be on the same plane as the first sensing element 210a and the second sensing element 210b and may have inclinations Δrₙ₁ and Δrₙ₂, respectively, with respect to a point C, which is located below the point (x, y). Also, the first protrusion 410a and the second protrusion 410b may be respectively spaced apart from the first sensing element 210a and the second sensing element 210b by d1 and d2, respectively. A distance between central points of the bottom surfaces of the first protrusion 410a and the second protrusion 410b may be I. When a force is applied to the center of the first protrusion 410a or the second protrusion 410b, displacement between the first protrusion 410a or the second protrusion 410b and the first sensing element 210a or the second sensing element 210b may occur only in a height direction. However, when the position of the applied force is between the first protrusion 410a and the second protrusion 410b as shown in FIG. 10, tilting may occur in the first protrusion 410a and the second protrusion 410b. Based on this principle, the substrate 200 may estimate not only the magnitude, but also the position of the force, based on the change in capacitance formed between the protrusions 410 and the sensing elements 210.

FIG. 11 shows vertical displacement and angular displacement of the protrusion 410. For example, (a) of FIG. 11 shows a case where a force is applied to a central point of the protrusion 410. In this case, the protrusion 410 may move only downwards. When a distance between a bottom surface of the protrusion 410 and the sensing element 210 is d₀, the vertical displacement of the protrusion 410 may be Δdₙ. The substrate 200 may detect a change in capacitance with respect to Δdₙ and may estimate the magnitude and position of the force.

(b) of FIG. 11 shows a case where a force is applied to a point not overlapping the protrusion 410, that is, to the outside of the protrusion 410. In this case, the protrusion 410 may move downwards and simultaneously may rotate. When a distance between the bottom surface of the protrusion 410 and the sensing element 210 is do, the vertical displacement of the protrusion 410 may be Δdₘ. Also, each displacement of the protrusion 410 may be Δrₙ. Here, the shape of the displacement of the protrusion 410 may be trapezoidal, which may be approximated as a rectangle. That is, each displacement Δrₙ may be regarded as Δdₘ according to a distance in a vertical direction between a central point of the sensing element 210 and the bottom surface of the protrusion 410. Each displacement due to external torsion may offset a change in area, and thus, the capacitance measured by the sensing element 210 may not change. Thus, the total change in capacitance measured by the sensing elements 210 may be calculated based on a change in distance between the protrusion 410 and the sensing element 210. For example, the total change in capacitance measured by the sensing elements 210 may be calculated by using a final distance represented as below.

$${d}^{′} = {d}_{0} - ( Δ {d}_{n} + Δ {d}_{rn} )$$

Here, d′ may represent the final distance between the sensing element 210 and the bottom surface of the protrusion 410.

As described above, the tactile sensor 11 according to embodiments may calculate the displacement between each sensing element 210 and each protrusion 410 based on the change in capacitance detected by each of the plurality of sensing elements 210, and may estimate the magnitude and position of the force, based on the calculated displacement.

The tactile sensor 11 according to embodiments may reflect an actual behavior of each protrusion 410 when a force is applied to the tactile sensor 11, in order to further accurately estimate the magnitude and position of the applied force. For example, based on experimentally organized data regarding the displacement of each protrusion 410, the displacement varying depending on the position of a force when the force is applied to various positions of a surface, the tactile sensor 11 may utilize a weight related to the probability of correspondence between the position of the force and the sensing element 210 when the force is applied to the plurality of protrusions 410. Here, the weight may be represented as an N*N matrix, where N may be equal to the number of sensing elements 210. Also, the tactile sensor 11 (the substrate 200) may derive a weight coefficient matrix indicating how similar measured capacitance data is to a weight matrix, based on the weight matrix and the capacitance data detected by each sensing element 210. Also, the tactile sensor 11 (the substrate 200) may calculate a coordinate of a contact point by using the origin of each sensing element 210 and the weight coefficient matrix. Additionally, the tactile sensor 11 (the substrate 200) may calculate a contact force at the position where the force is applied, based on the weight coefficient matrix and force data detected by each sensing element 210.

The tactile sensor 11 (the substrate 200) may estimate the magnitude and position of the force by using the capacitance data detected by the plurality of sensing elements 210 and the weight data. Here, the weight data refers to data related to a probability in which a position where a force is applied may correspond to a specific sensing element 210 when the force is applied to the protrusion 410 corresponding to any one sensing element 210. Thus, the tactile sensor 11 may further accurately estimate the actual force by using the weight data obtained by simulating deformation of the intermediate member (300) that exhibits a different behavior from a rigid body.

The tactile sensor 11 (the substrate 200) may calculate the weight coefficient matrix, based on the weight matrix representing the weight data and the transpose matrix of the capacitance data, and may calculate the position coordinate of the contact force, based on the origin positions of the plurality of sensing elements 210 and the weight coefficient matrix. Also, the substrate 200 may calculate the magnitude of the contact force, based on the weight coefficient matrix and the contact force data detected by each of the plurality of sensing elements 210. Thus, the tactile sensor 11 may further accurately estimate the magnitude and position of the force.

For example, the weight matrix M may be calculated as follows.
1. An average displacement of each row may be calculated based on n*6 data measured by applying a single force to the protrusion 410 corresponding to any one sensing element 210.
2. A displacement matrix V may be calculated to indicate a difference between a displacement measured by the corresponding sensing element 210 and the average displacement.
3. Data may be compressed into a 6*6 matrix by using V^{T}V.
4. An orthonormal basis of the generated matrix may be analyzed to identify vectors mainly included in the matrix. Here, the vector may indicate a sensing element configured to generate a most sensitive response from among the entire sensing elements 210, when a force is applied to the protrusion 410 corresponding to the corresponding sensing element 210.
5. This process may be repeated for the remaining sensing elements 210 to derive six 6*1 vectors and derive a 6*6 weight matrix M based on the six 6*1 vectors. Here, the weight matrix M may indicate the probability of correspondence between a position where a force is applied and a specific sensing element 210, when the force is applied to the protrusion 410 corresponding to any one sensing element 210.

As described above, the tactile sensor 11 according to embodiments may continuously estimate the position of the applied force without dead zones, by utilizing the geometric relationship between the sensing elements 210 in the weight matrix.

As shown below, the tactile sensor 11 (the substrate 200) may derive a weight coefficient matrix A, based on an inverse matrix of the weight matrix M and a transpose matrix of the capacitance data detected by each sensing element 210. A may indicate a similarity between the actually measured capacitance data and the weight matrix M.

$${{M}^{- 1} \cdot \{ {C}_{1} {C}_{2} {C}_{3} {C}_{4} {C}_{5} {C}_{6} ]}^{T} = λ$$

The tactile sensor 11 (the substrate 200) may calculate position coordinates pₓ and p_{y} of a contact force, based on vectors O and A indicating the origin positions of the sensing elements 210, as shown below.

$$O \cdot λ = {[ {p}_{x} {p}_{y} ]}^{T}$$

As described above, the contact force may vary depending on the coordinates of the contact position. A weight of each sensing element 210 may vary depending on the position coordinates pₓ and p_{y}, and thus, a contact force F may be calculated using λ as below.

$${λ}^{T} \cdot {[ {F}_{1} {F}_{2} {F}_{3} {F}_{4} {F}_{5} {F}_{5} ]}^{T} = F .$$

F₁ to F₆ may represent six pieces of force data detected by each sensing element 210.

The arithmetic operation, calculation, and/or estimation of the tactile sensor 11 described above may be performed by the substrate 200, by the gripper controller 30, or separately by the substrate 200 and the gripper controller 30. For example, the substrate 200 may perform an operation of estimating the position and magnitude of the force through the control module 220, or the substrate 200 may transmit, to the gripper controller 30, through a communication module, a change in capacitance detected by the plurality of sensing elements 210, and the gripper controller 30 may estimate, based on the transmitted change in capacitance, the position and magnitude of the force.

A tactile sensing method according to embodiments may detect a force by using the tactile sensor 11 described above.

In one embodiment, the tactile sensing method according to embodiments may be a method of detecting a force by using the tactile sensor 11 including the substrate 200 including the plurality of sensing elements 210, the cover 400 including a conductive material, covering the substrate 200, and including the plurality of protrusions 410, and the intermediate member 300 having an insulating property and arranged between the substrate 200 and the cover 400.

The tactile sensing method according to embodiments may include: an operation in which, as a force is applied to a point of the cover 400, the intermediate member 300 may be deformed so that at least one protrusion 410 adjacent to the point where the force is applied may be displaced to be vertically compressed or to tilt toward the point where the force is applied; an operation in which the plurality of sensing elements 210 of the substrate 200 may detect changes in capacitance corresponding to changes in distance between the plurality of sensing elements 210 and the plurality of protrusions 410 due to the displacement; and an operation in which the control module 220 of the substrate 200 may estimate a magnitude and a position of the force applied to the cover 400, based on the changes in capacitance.

In one embodiment, the estimating of the magnitude and the position of the force may be performed by using capacitance data detected by the plurality of sensing elements 210 and a weight matrix, wherein the weight matrix may be derived based on a correlation of a displacement measured by each of all of the sensing elements when the force is applied to the protrusion corresponding to a specific sensing element, and may indicate a probability of correspondence between the position where the force is applied and the specific sensing element.

In one embodiment, the estimating of the magnitude and the position of the force may include: calculating a weight coefficient matrix by multiplying an inverse matrix of the weight matrix by a transpose matrix of the capacitance data; and calculating position coordinates of a contact force by calculating the weight coefficient matrix and vectors representing origin positions of the plurality of sensing elements 210.

### Embodiment—Method of Manufacturing Tactile Sensor

A dedicated molding frame was designed to manufacture the cover 400 including six protrusions 410. The dedicated molding frame was 3D printed using a Vero White material to maintain a smooth surface of the cover 400. To enable the cover 400 to function as a ground electrode, the cover 400 was manufactured using PDMS containing conductive carbon black. The cover 400 was manufactured by performing a vacuum degassing process for 3 minutes on the PDMS containing 10 wt % of carbon black and performing heat treatment on the PDMS in an oven at 70° C. for 30 minutes.

The substrate 200 may include a PCB, and the control module 220 including a CDC chip (AD7147) was arranged below the substrate 200. The data measured by the control module 220 is transmitted to the gripper controller 30 via an inter-integrated circuit (I2C) communication interface operating at a sampling rate of 200 Hz. The substrate 200 includes pins for an interface and a power supply. The size of the manufactured substrate 200 was 20*10 mm² and the thickness thereof was 1 mm.

The base 100 was formed of an aluminum alloy.

After inserting the substrate 200 into the base 100, an elastomer (KE-441, Shin-Etsu Chemical), which is the material of the intermediate member 300, may be poured, and then the cover 400 may be attached thereto. Next, the elastomer was cured at room temperature for one day to connect the cover 400 to the substrate 200, the assembly was completely manufactured by spacing the protrusions 410 and the sensing elements 210 apart by 0.1 mm. The tensile strength of the cured elastomer is 2 MPa, and the adhesive strength is 0.7 MPa.

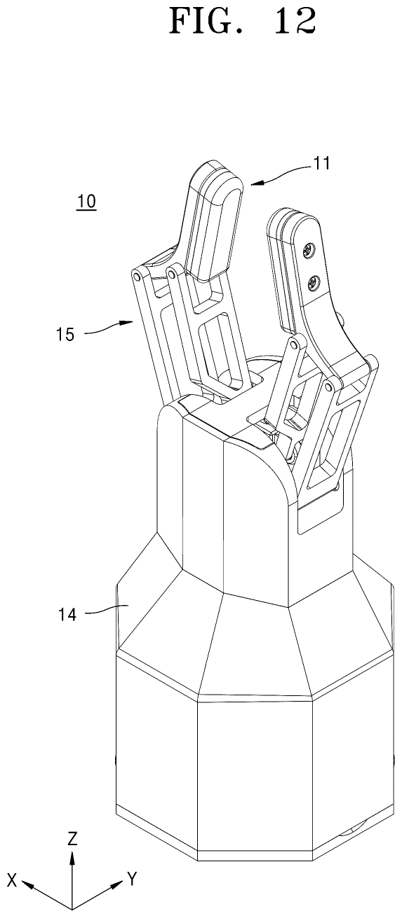

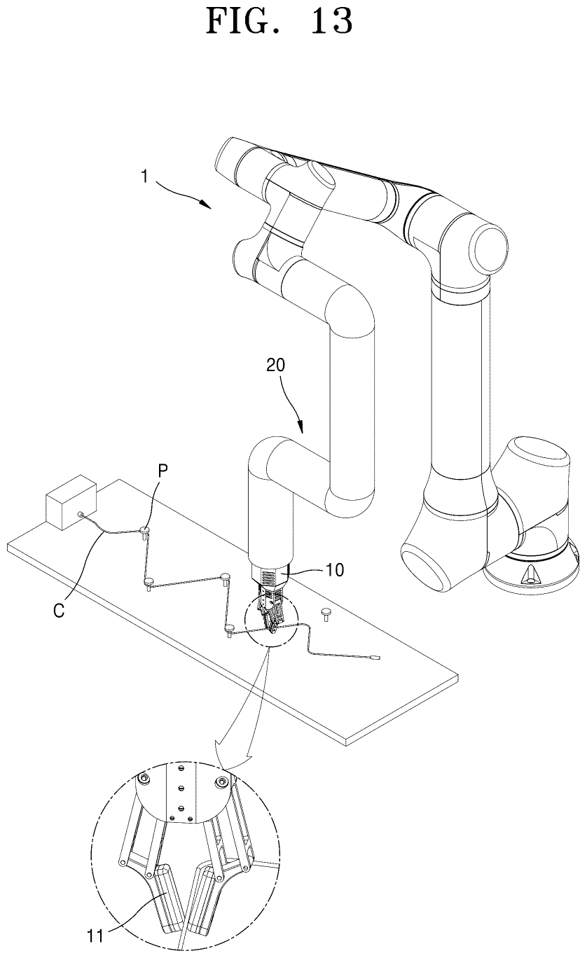

FIG. 12 illustrates a gripper 10 including a tactile sensor 11 according to embodiments and FIG. 13 illustrates a robot 1 performing a cable C manipulation operation according to embodiments of embodiments.

The gripper 10 may include a housing 14 and a plurality of fingers 15. The gripper 10 may further include an actuator for moving the plurality of fingers 15. The housing 14 accommodates the actuator, and the actuator may drive the plurality of fingers 15. For example, the actuator is connected to a pair of fingers 15 and may grip an object by closing or opening the pair of fingers 15. An end of the housing 14 may be connected to the robot arm 20 of the robot 1. Each of the plurality of fingers 15 may include a tactile sensor 11. The tactile sensor 11 may be mounted on a surface where the finger 15 contacts an object. The gripper 10 may perform delicate tasks based on the force sensed by the tactile sensor 11.

In one embodiment, the gripper 10 may perform an operation of manipulating a cable C. For example, as shown in FIG. 13, the gripper 10 may perform an operation of tensioning the cable C in a lengthwise direction while securing the cable C to a pin P.

Although the present disclosure has been described with reference to preferred embodiments, it will be understood by those skilled in the art that various changes in form and details may be made therein without departing from the spirit and scope of the present disclosure. Therefore, the embodiments disclosed herein should be considered in a descriptive sense only and not for purposes of limitation. The scope of protection of the present disclosure should be construed based on the appended claims, and all technical ideas within the scope of equivalents thereof should be construed as being included within the scope of the present disclosure.

What is claimed is:

1. A tactile sensor comprising:
a base;
a substrate accommodated in the base and comprising a plurality of sensing elements;
a cover arranged to cover the substrate and comprising a conductive material, the cover comprising a plurality of protrusions forming capacitance with the plurality of sensing elements; and
an intermediate member provided between the substrate and the cover,
electrically insulating the substrate from the cover, and comprising a plurality of receiving grooves for receiving the plurality of protrusions, respectively,
wherein the cover and the intermediate member are configured such that the plurality of protrusions are displaced relative to the plurality of sensing elements so that the capacitance between the plurality of sensing elements and the plurality of protrusions changes in response to a force applied to the cover.

2. The tactile sensor of claim 1, wherein the plurality of protrusions are positioned on a surface of the cover facing the substrate and configured to move or tilt in a direction perpendicular to the surface of the substrate in response to the force applied to the cover.

3. The tactile sensor of claim 1, wherein the plurality of protrusions each have a tapered shape with a cross-sectional area gradually narrowing toward the substrate.

4. The tactile sensor of claim 3, wherein the plurality of protrusions each have a truncated cone shape, and
the plurality of receiving grooves each have a shape corresponding to the truncated cone shape.

5. The tactile sensor of claim 1, wherein the plurality of sensing elements overlap bottom surfaces of the plurality of protrusions and are spaced apart from the plurality of protrusions in a height direction.

6. The tactile sensor of claim 1, wherein the plurality of protrusions are on an inner surface of the cover, and
an outer surface of the cover has a smooth surface without an uneven portion.

7. The tactile sensor of claim 1, wherein the base comprises an inner groove for accommodating the substrate.

8. The tactile sensor of claim 1, wherein the substrate comprises a control module configured to estimate a displacement of the plurality of protrusions based on a change in capacitance detected by the plurality of sensing elements and to estimate a magnitude and a position of the force applied to the cover.

9. The tactile sensor of claim 8, wherein the control module is configured to estimate the magnitude and the position of the force based on capacitance data detected by the plurality of sensing elements and weight data, wherein the weight data indicates a probability in which, when a force is applied to a protrusion corresponding to any one sensing element, a position where the force is applied corresponds to a specific sensing element.

10. The tactile sensor of claim 9, wherein the control module is further configured to:
calculate a weight coefficient matrix based on a weight matrix representing the weight data and a transpose matrix of the capacitance data; calculate position coordinates of a contact force based on origin positions of the plurality of sensing elements and the weight coefficient matrix; and
calculate a magnitude of the contact force based on the weight coefficient matrix and the capacitance data detected by each of the plurality of sensing elements.

11. The tactile sensor of claim 1, further comprising a connector fastened through the base and the cover,
wherein the cover is configured to be grounded through the connector.

12. The tactile sensor of claim 1, wherein the cover comprises a polydimethylsiloxane (PDMS) material containing conductive carbon black.

13. The tactile sensor of claim 1, wherein the plurality of sensing elements are arranged to form a plurality of rows in a longitudinal direction of the substrate, and
the plurality of protrusions are arranged to correspond to the plurality of sensing elements, respectively.

14. The tactile sensor of claim 1, wherein the intermediate member comprises an elastic material and is configured such that the plurality of receiving grooves for receiving the protrusions are restored when the force applied to the cover is removed.

15. A method of detecting a force by using a tactile sensor comprising a substrate comprising a plurality of sensing elements, a conductive cover covering the substrate and comprising a plurality of protrusions, and an intermediate member having an insulating property and arranged between the substrate and the cover, the method comprising:
an operation in which, as a force is applied to a point of the cover, the intermediate member is deformed so that at least one protrusion adjacent to the point where the force is applied is displaced to be vertically compressed or to tilt toward the point where the force is applied;
an operation in which the plurality of sensing elements of the substrate detect changes in capacitance corresponding to changes in distance between the plurality of sensing elements and the plurality of protrusions due to the displacement; and
an operation in which a control module of the substrate estimates a magnitude and a position of the force applied to the cover based on the changes in capacitance.

16. The method of claim 15, wherein the operation of estimating the magnitude and the position of the force is performed by using capacitance data detected by the plurality of sensing elements and a weight matrix, wherein the weight matrix is derived based on a correlation of a displacement measured by each of all of the sensing elements when the force is applied to the protrusion corresponding to a specific sensing element and indicates a probability of correspondence between the position where the force is applied and the specific sensing element.

17. The method of claim 16, wherein the operation of estimating of the magnitude and the position of the force comprises:
calculating a weight coefficient matrix by multiplying an inverse matrix of the weight matrix by a transpose matrix of the capacitance data; and
calculating position coordinates of a contact force by calculating the weight coefficient matrix and vectors representing origin positions of the plurality of sensing elements.

18. A gripper comprising:
one or more fingers; and
a tactile sensor mounted on the one or more fingers,
wherein the tactile sensor comprises:
a base;
a substrate accommodated in the base and comprising a plurality of sensing elements;
a cover arranged to cover the substrate and comprising a conductive material, the cover comprising a plurality of protrusions forming capacitance with the plurality of sensing elements; and
an intermediate member provided between the substrate and the cover, electrically insulating the substrate from the cover, and comprising a plurality of receiving grooves for receiving the plurality of protrusions, respectively,
wherein the cover and the intermediate member are configured such that the plurality of protrusions are displaced relative to the plurality of sensing elements so that the capacitance between the plurality of sensing elements and the plurality of protrusions changes in response to a force applied to the cover.

19. The gripper of claim 18, wherein the tactile sensor is arranged on an object contact surface of the one or more fingers, and the cover is mounted to face an outer side of the one or more fingers, and
the one or more fingers comprise a pair of fingers arranged to face each other, and the tactile sensor is mounted on each of the pair of fingers.

20. The gripper of claim 18, further comprising:
a driver configured to drive the one or more fingers to move with respect to each other; and
a gripper controller configured to control the driver based on capacitance data output from the tactile sensor.
